(19) United States
(12) Patent Application Publication
(10) Pub. No.: US 2006/0143568 A1
(43) Pub. Date: Jun. 29, 2006

(54) Method and apparatus for enhanced browsing

(76) Inventors: Scott Milener, San Francisco, CA (US); Wendell Brown, Las Vegas, NV (US); Steven Lurie, San Francisco, CA (US)

Correspondence Address: PARK, VAUGHAN & FLEMING LLP, 39180 LIBERTY STREET, SUITE 103, FREMONT, CA, 94538, US

(21) Appl. No.: 11/354,369

(22) Filed: Feb. 14, 2006

Related U.S. Application Data
(63) Continuation-in-part of application No. 10/985,700, filed on Nov. 10, 2004.

(51) Int. Cl. G06F 9/00

(52) U.S. Cl. 715/738; 715/862; 715/856; 715/760; 715/764

(57) ABSTRACT

A method and apparatus for enhanced browsing. The apparatus includes a user interface for presenting an enhanced browsing window containing a second page of content identified by a link in a first page displayed in a browser. The apparatus may include a prefetcher for prefetching the content, a cache for storing the window, and a customizer for customizing the window or content displayed in the window. When a user places a cursor near or over the link (e.g., over an icon placed near the link), the window is automatically displayed with content from the second page. One or more objects (e.g., ads, navigation controls) may be stripped from the second page before displaying remaining content in the window. The window may be converted into a full second browser in response to predetermined user activity within the window (e.g., clicking a control, entering data into a data entry field).

### RELATED APPLICATIONS

This application is a continuation-in-part of U.S. patent application Ser. No. 10/985,700, titled “Method and Apparatus for Enhanced Browsing” and filed Nov. 10, 2004, which is incorporated herein by reference.

This application is related to U.S. patent application Ser. Nos. 10/985,553, 10/985,628 and 10/986,509, all of which were filed Nov. 10, 2004 and are incorporated herein by reference. This application is also related to U.S. patent application Ser. No. 11/180,261, filed Jul. 13, 2005 and U.S. patent application Ser. No. 11/264,418, filed Nov. 1, 2005, both of which are also incorporated herein by reference.

### BACKGROUND

This invention relates to the field of computer systems. More particularly, a method and apparatus are provided for improving the quality and efficiency of a user's browsing experience.

Today's browsers provide users with substandard browsing experiences, primarily because their focus is limited to a single web page at any given time. Specifically, a browser generally displays just a single page, which may include hyperlinks to any number of other pages or sites. The browser does not allow the user to see what is on a linked page until she redirects the browser to that page (e.g., by selecting a hyperlink). Only then can the user determine whether that page contains anything of interest to her. If not, she must retrace her action to return to another possible branching point (e.g., by clicking a “back” button).

This pattern—of selecting a link to go to a new page, reviewing its content, and possibly selecting a link on that page—may continue any number of levels deep, all of which must be retraced to return to a starting point. When that starting point is a list of links to web sites or pages (e.g., at a search engine site) or a list of links to goods or services (e.g., at a retail or auction site), a user may have to traverse a number of chains of linked pages, and continually return to the starting point, in the hope of finding content that more closely matches her interest.

In addition, when the user selects a link to navigate to a corresponding page, only then does the browser retrieve the content of that page. Depending on the bandwidth or type of communication link available to the user, and the status of the starting point and target web site (e.g., how congested the web server is), Delays in loading a target page are particularly common if the page contains many objects, scripts or rich media formats, or if the target web site's servers are overloaded (e.g., because of a spike in interest in the web site or target page).

When the user accesses numerous pages, as is typical during a search session with a search engine or retail/auction site, the combined duration of the time lags and loading delays can cause a significant amount of wasted time. A user wishing to quickly review several links or pages can become very frustrated with her browser's response time. And, if an error is encountered while trying to load a page, the user may have to try reloading it multiple times before she is successful or before she gives up.

Further, when a user selects a link to a news story, magazine article, book review or other discrete content item, the item is usually served with various objects that are not part of the primary content the user desires, and which tend to clutter the user's view. For example, a linked page may include advertisements navigation controls and/or other objects that have little, if anything, to do with the primary content. The user may have to use scroll bars or take additional action (e.g., enter keyboard commands such as PAGE UP or PAGE DOWN) to access all the text. The clutter is often distracting as well as inconvenient, and may decrease the user's enjoyment of the content.

### SUMMARY

In one embodiment of the invention, a method and apparatus are provided for enhanced browsing of electronic data. In one method, a first page of data (e.g., a web page, an electronic mail message) displayed in a browser may contain any number of links to other pages (or other content).

When the user mouses-over a link to a second page, or otherwise indicates an interest in the linked content, content from the second page is retrieved and an enhanced browsing window containing the content is displayed. Illustratively, the user's interest in the link may be determined by his mousing-over the link or mousing-over an icon displayed when the user places a cursor near or over the link. In this embodiment, actual content of a linked page is retrieved (e.g., not just an image of the content).

In another embodiment of the invention, content from the second page may be prefetched even before a user expresses an interest in the link. An enhanced browsing window may be generated and populated with the prefetched content, but the window is kept invisible until the user expresses an interest in the link or the content.

An enhanced browsing window may be smaller than a browser window, and may be located anywhere on top of or in place of the browser. Content identified by a link displayed within an enhanced browsing window may also be fetched or prefetched, so that a user may enjoy multiple levels of enhanced browsing. If the cursor is moved out of the window, the enhanced browsing window may close. Another enhanced browsing window may open with other content if the user mouses-over a different link in the first page, or content from the different link may replace the content displayed in the original enhanced browsing window.

In one embodiment, if a user takes some predetermined action in the enhanced browsing window, such as by clicking within the displayed content or on a particular control, or by entering text into a form, the window may be automatically converted into a full browser window, and may overlay or replace the browser displaying the first page. Enhanced browsing may then be available within the new browser window.

In another embodiment, content fetched or prefetched for display in an enhanced browsing window may be stripped of extraneous object—objects other than the primary content, which may be a news or magazine article, a product review, a description of an item for sale, etc. Objects that may be stripped include navigation controls, advertisements, logos, links, etc.

In an embodiment of the invention described herein, an enhanced browsing window differs from a traditional browser window in that the enhanced browsing window may be opened and/or closed without the user clicking on any links or controls—the user merely needs to move or position his mouse over or near a link to open the window, and move the mouse out of the window to close it.

In one embodiment of the invention, an enhanced browsing apparatus includes a fetcher for fetching or prefetching content identified by links in a page displayed by a browser, a user interface for generating and displaying an enhanced browsing window, and a cache for storing the enhanced browsing window.

### DESCRIPTION OF THE FIGURES

FIG. 1 is a block diagram depicting an enhanced browsing apparatus according to one embodiment of the invention.

FIG. 2 depicts an enhanced browsing window according to one embodiment of the invention.

FIG. 3 depicts an enhanced browsing window according to one alternative embodiment of the invention.

FIG. 4 is a flowchart demonstrating a method of providing enhanced browsing according to one embodiment of the invention.

FIG. 5 depicts an enhanced browsing window according to another alternative embodiment of the invention.

FIGS. 6-7 illustrate an enhanced browsing window automatically convertible into a full browser, according to one embodiment of the invention.

FIGS. 8-9 demonstrate an embodiment of the invention in which one or more extraneous objects may be stripped from content to be displayed in an enhanced browsing window.

FIG. 10 is a flowchart demonstrating another method of performing enhanced browsing, according to one embodiment of the invention.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In an embodiment of the invention, a method and apparatus are provided for enhanced browsing of electronic data. A user browses or navigates his browser to a first electronic page (e.g., web page, document, electronic mail message, image) that contains one or more links (e.g., hyperlinks) or references to other pages or content. When he selects (e.g., mouses-over or places a cursor over) a link to a second page or an object (e.g., icon) associated with such a link, an enhanced browsing window containing content of the second page is displayed on top of or in front of the browser window.

The enhanced browsing window contains actual content from the second page, such as HTML (HyperText Markup Language), SGML (Standard Generalized Markup Language), XML (Extensible Markup Language) or some other markup language, not just an image (e.g., a thumbnail, a .gif or .jpg image) of the content. The second page displayed within the enhanced browsing window may be considered “navigable” content, because links within the second page can be selected and followed within the window. This differs from non-navigable content such as a jpeg image of a web page.

The content of the second page may be prefetched before the user chooses to preview it, and so the enhanced browsing window may be displayed almost immediately when the user selects the link to the second page. The contents of the window may change as the user mouses-over other links, or separate enhanced browsing windows may be generated for each link.

For purposes of describing embodiments of the invention, a “link” that identifies or is associated with data that may be retrieved or prefetched may take any form—graphical, textual or other. A link may therefore include any object (e.g., an icon) or information that embodies or is accompanied by a link or reference to other electronic data or content.

In different embodiments of the invention described herein, an enhanced browsing window may operate differently depending on user activity or action within the window, the type of content displayed in the window, etc. For example, controls may be provided with an enhanced browsing window for converting the window into a full browser. Further, content presented in an enhanced browsing window may be stripped of advertisements or other objects or, conversely, may be augmented with advertisements or other objects.

Enhanced Browsing

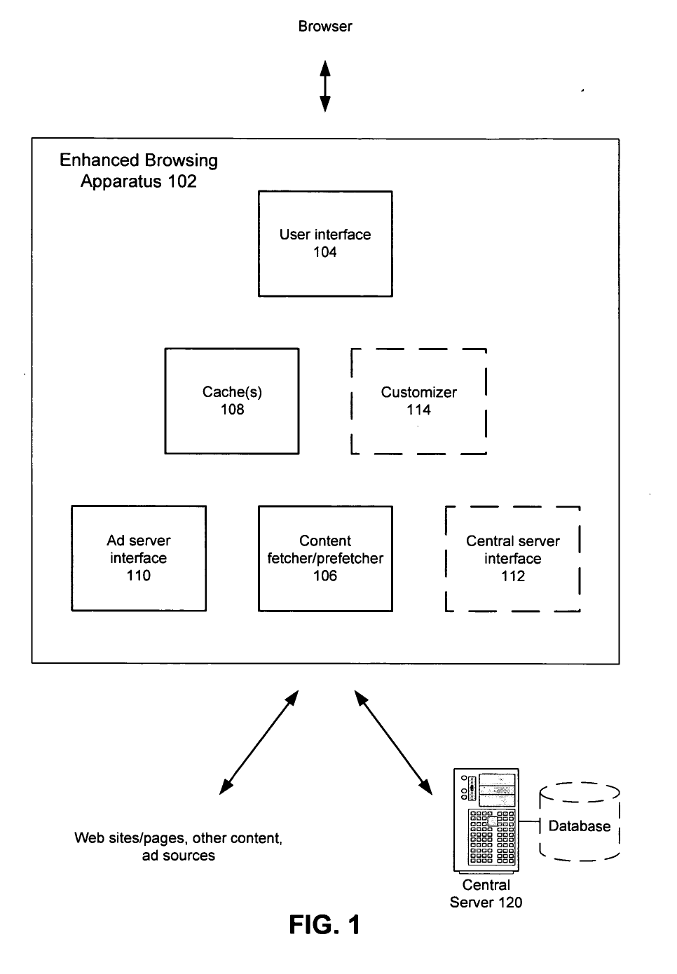

FIG. 1 depicts an apparatus for enhanced browsing of electronic data, according to one embodiment of the invention. In the illustrated implementation, the apparatus is configured as a plug-in or add-on to a web browser such as Internet Explorer by Microsoft Corporation, Firefox by the Mozilla Foundation, Netscape Communicator by Netscape Communications Corporation, etc. In other implementations, the apparatus may be provided as part of a complete browser or other application, or as a plug-in or add-on to a different type of application (e.g., electronic mail, instant messaging, database).

The term “target link” may be used herein to refer to a link whose content is, or may be, selected for retrieval for display in an enhanced browsing window. Similarly, the term “target content” may be used to refer to content that is or should be retrieved for display, with or without prefetching.

Enhanced browsing apparatus 102 operates on virtually any type of computing device (e.g., computer, personal digital assistant, web-enabled telephone) and comprises user interface 104, content fetcher/prefetcher 106, cache(s) 108, ad server interface 110, optional central server interface 112 and optional customizer 114. The apparatus is linked or coupled to a host browser in a manner similar to other plug-ins.

Enhanced browsing apparatus 102 is coupled to computer systems or networks containing web sites, web pages, documents, electronic mail messages and/or other electronic data or content. The apparatus may be coupled to these entities by any types of communication links, which may be shared (e.g., network) or dedicated, and wired or wireless. In particular, apparatus 102 may be coupled to a central server, which may include or be coupled to a database or other collection of data for facilitating enhanced browsing, as described below. Content accessed through enhanced browsing apparatus 102 may also, or instead, be stored on the same computing device as the apparatus.

User interface 104 is configured to build, display and manipulate an enhanced browsing window. The user interface may also provide any number and type of controls to allow a user to navigate or manipulate content within such a window, such as buttons, icons, a toolbar, etc., and may also accept keyboard input (e.g., key sequences using the CTRL or ALT keys, up and down arrow keys, PAGE UP or PAGE DOWN keys).

The various controls may allow a user to initiate or terminate fetching or prefetching of target content, open or close an enhanced browsing window, navigate his or her browser to retrieved content (e.g., by directing the browser to a page displayed in an enhanced browsing window), fetch content linked to content displayed in an enhanced browsing window, convert an enhanced browsing window into a full browser window, etc.

In particular, user interface 104 may provide controls, menus and/or other means that allow the user to customize the enhanced browsing apparatus or change how it operates. User customization options may include: size or position of an enhanced browsing window, number of target links from which to fetch content at a time (e.g., none, all, ten, twenty), how to identify or prioritize target links, default action(s) to take in response to certain user activity (e.g., when the user clicks inside a window or on a link within the displayed target content), how long to delay opening, closing or changing an enhanced browsing window, etc. A user's customization choices may be applied by user interface 104 and/or customizer 114.

In the illustrated embodiment of the invention, user interface 104 builds an enhanced browsing window when target content is prefetched, but keeps the window invisible until and unless the user actually indicates an interest in (e.g., mouses-over) the associated target link or an icon or indicator associated with the link. The window is then made visible. Invisible windows may be stored in cache(s) 108. Alternatively, target content may be fetched only when the user's interest in the target content is determined, and then used to populate an enhanced browsing window that is immediately displayed.

In one embodiment of the invention, an icon (e.g., an enhanced browsing icon) is displayed in association with (e.g., adjoining) a target link when a user mouses-over or near the link. An enhanced browsing window containing the target content is displayed if the user mouses-over the icon.

Content fetcher/prefetcher 106 is responsible for fetching or prefetching content from appropriate sources (e.g., web sites, databases, document repositories, electronic mail gateways) based on default criteria and/or a user's specified criteria. For example, fetcher/prefetcher 106 may commence prefetching target content immediately after the browser loads or displays a page containing one or more target links, thereby taking advantage of communication bandwidth that is idle while a user examines the page. Any number of links on the browser page may be treated as target links.

Content fetcher/prefetcher 106 and/or some other component of enhanced browser apparatus 102 (e.g., a separate target identification module) may be configured to identify target links, using a prefetch template or other means. A prefetch template may be designed for a specific page (or set of pages) and indicates where on the page a target link (or set of target links, such as a list of search results) may be found. Alternatively, any list of links or set of links apparently arranged in a list may be treated as target links.

Prefetching is not required for all embodiments of the invention. Although prefetching content may speed up a user's browsing or previewing of content, other benefits of the invention may be enjoyed without content being prefetched.

For example, it may be desirable to detect unwanted content (e.g., spyware, viruses, pornography) regardless of whether the content is being prefetched or just fetched. Or, a user may find it helpful to be reminded that he or she has already viewed the content, saved the target link to a favorites list, decided or indicated whether the content is or is not helpful or enjoyable, etc.

Cache(s) 108 include one or more caches for storing target links, target content, prefetch templates, enhanced browsing windows, a user history (e.g., a sequence of sites browsed or previewed) and/or other data. Cache 108 may therefore store the content of an enhanced browsing window and/or data or content being manipulated by another component of apparatus 102.

In the embodiment of the invention depicted in FIG. 1, a cache used by enhanced browsing apparatus 102 is distinct from any cache(s) maintained by the browser. However, cache(s) 108 need not be included in all embodiments of the invention, or its functions may be performed by some other component of apparatus 102.

Optional customizer 114 is configured to customize target content before, during or after it is displayed in an enhanced browsing window. In one implementation, customizer 114 may strip advertisements, banners, logos, images and/or other secondary objects from target content, thereby leaving just “primary” content for display. This may allow a user to more easily or clearly view a textual news story or article, for example, without extraneous clutter.

In one implementation, if a target link's URL (Uniform Resource Locator) matches a known URL, a template or filter for that URL may be applied to identify and remove secondary objects. If the target link does not match any URLs for which filters are available, a best effort may be employed with a generic filter to remove unwanted content. For example, a site-specific filter may identify specific objects as constituting primary or secondary content, while a generic (or URL-specific) filter may involve examining HTML tags, attributes, text, source, data type and/or other criteria. Thus, with any given web site identified in a target link, any specific objects or types of objects may be retained (e.g., text, images identified within the text) or removed (e.g., navigation controls, advertisements).

In another implementation, customizer 114 may insert one or more objects into target content, such as an advertisement, an image, a logo or other branding, etc. Customizer 114 may operate as a separate component of enhanced browsing apparatus 102, or some other component (e.g., user interface 104) may comprise a customizer or perform its functions.

In other embodiments, an enhanced browsing apparatus may include more or fewer components, or the functionality of the components described above may be distributed in a different fashion. For example, an enhanced browsing apparatus may also include a component for scanning fetched or prefetched content for viruses, malware, pornography and/or other material unsuitable for, or undesired by, certain users.

One alternative embodiment of the invention may be implemented without cache 108 and without prefetching. In this embodiment, when a user browses a first page and mouses-over or hovers near a link to a second page (or a control or icon associated with the link), an enhanced browsing window may still be displayed with content from the second page, but the content may not be retrieved until the mouse-over. And, the apparatus may make use of the browser's cache or another cache already available on the user's computing device.

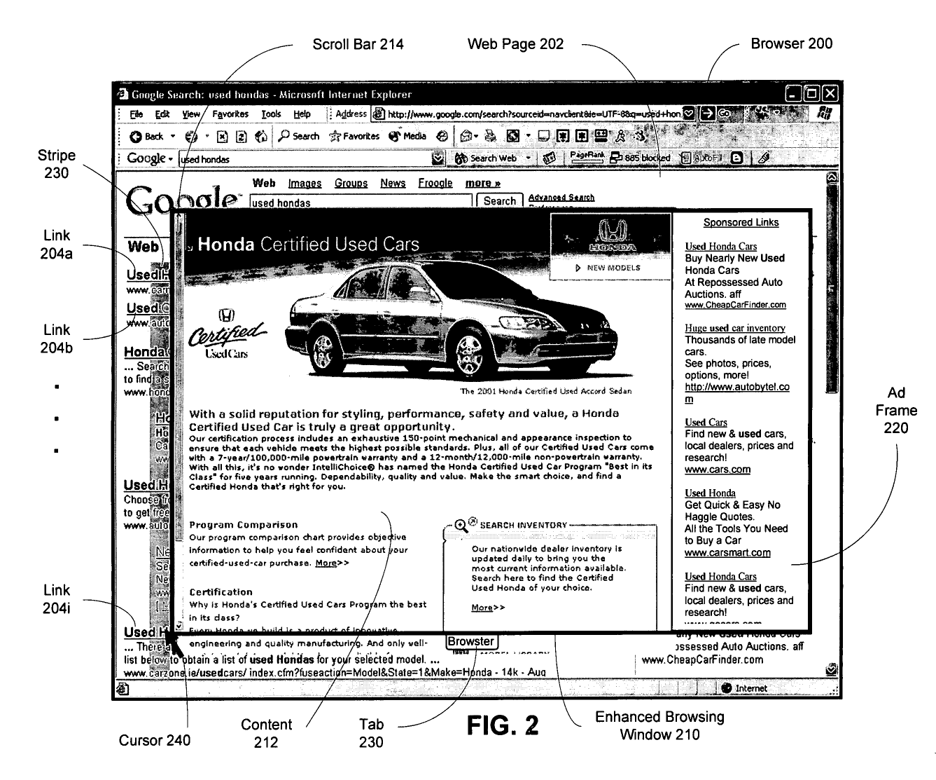

FIG. 2 depicts an enhanced browsing window according to one embodiment of the invention. In FIG. 2, browser 200 (e.g., Microsoft Internet Explorer) is open to a first page 202, which includes a list of links 204 (e.g., 204a-204i). Links 204 are search results in this example, but in other implementations may comprise any types of links, to any type of content. The content identified by or associated with links 204 may or may not be inter-related. For example, if the links comprise search results of one search operation, as do links 204 in page 202, their content may be considered inter-related.

Enhanced browsing window 210 is positioned so as to allow a user to see portions of links 204. However, in other implementations, window 210 may cover links 204 to a greater or lesser degree. Alternatively, any or all of window 210 may be made fully or partially transparent, so that some or all of the content of browser page 202 is viewable even when window 210 is displayed. As described above, enhanced browsing window 210 may be constructed and cached prior to being displayed.

When a user mouses-over the link (e.g., link 204i) corresponding to the content 212 of the enhanced browsing window, or an icon associated with the link, the window is automatically displayed. The size and/or position of window 210 may be adjustable by a user, but limits may be placed on the user's ability to re-size or re-position the window.

Ad frame 220 is also positioned within enhanced browsing window 210. The ad frame may be arranged in any position or along any edge of the window. Illustratively, ads received along with or as part of content 212 from a location identified by link 204c may be removed or replaced prior to display of the content within window 210.

Content 212 may be reduced in font size to allow it to more fully or easily fit within window 210, and/or scroll bars (e.g., scroll bar 214) may be provided to allow a user to scroll vertically and/or horizontally. The user may be able to close window 210 by simply moving the cursor out of the enhanced browsing window (e.g., to somewhere within browser page 202).

If the user clicks (e.g., left-clicks) within window 210, page 202 of browser 200 may be replaced by the page or content displayed in the enhanced browsing window. The user may be able to close window 210 by simply moving the cursor out of the enhanced browsing window (e.g., to somewhere within browser page 202) or taking other action (e.g., right-clicking within the enhanced browsing window).

In one embodiment of the invention, a selectable tab or drop-down menu 230 is positioned adjacent to, or within, enhanced browsing window 210. Clicking on tab 230 opens a menu allowing a user to customize one or more features of the enhanced browsing window or apparatus (e.g., size of window 210, how long the user must pause over a link before the window opens, degree of transparency). Alternatively, menus or controls for customizing a user's enhanced browsing may be located elsewhere within enhanced browsing window 210, or may be summoned with a particular command or user interface input.

In other embodiments of the invention, other user interface controls or options may be provided. For example, a set of controls may be provided to allow a user to specify how the enhanced browsing apparatus should act when the user takes certain action (e.g., clicks on or mouses-over a link within an enhanced browsing window, clicks within a window but not on a link, mouses-over a second target link while a first link's content is still being previewed).

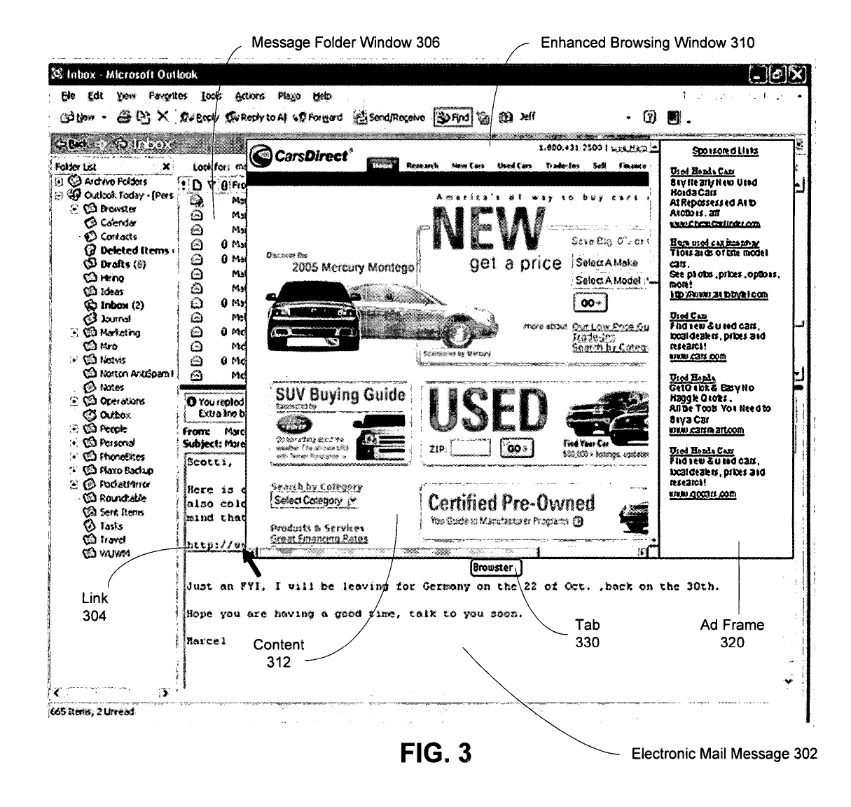

FIG. 3 depicts an enhanced browsing window according to another embodiment of the invention. In FIG. 3, enhanced browser window 310 is employed to preview content within an electronic mail application (e.g., Microsoft Outlook).

In the illustrated implementation, when electronic mail message 302 is displayed, content identified by or associated with a link included in the message (e.g., link 304) may be prefetched. Thus, content 312 within enhanced browsing window 310 comprises content retrieved from a location identified by link 304. The enhanced browsing window also includes ad frame 320, which may present ads relevant to content 312 or message 302.

In another implementation, an enhanced browsing window may be employed to preview content of electronic mail messages, such as messages listed or indexed in message folder window 306. The target content of an electronic mail message fetched or prefetched for display in an enhanced browsing window in this implementation may be automatically scanned for viruses, spyware, cookies or other types of malware or objectionable content. Any such content may be excised and/or a warning may be displayed to the user.

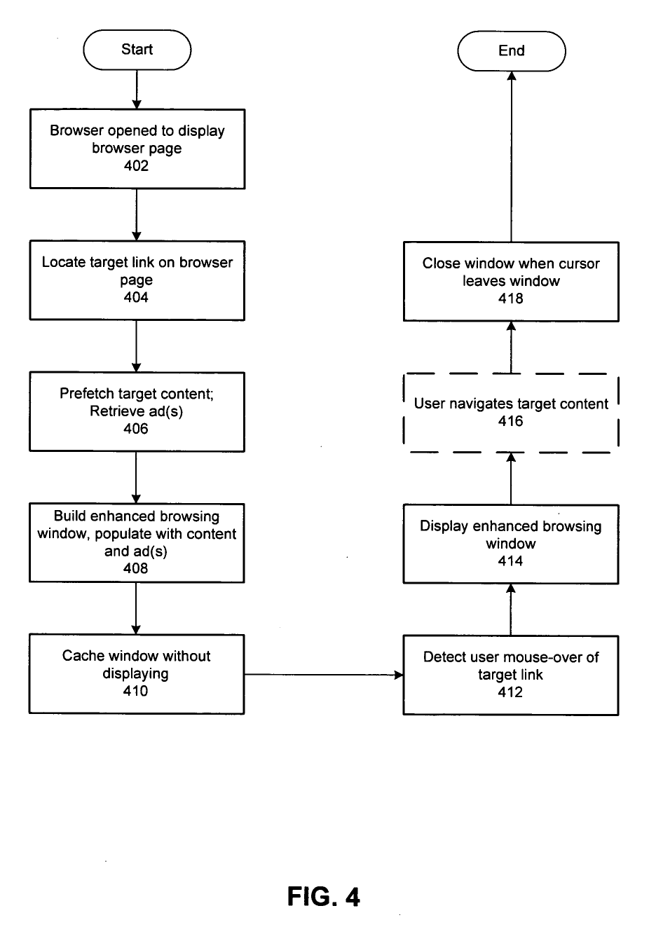

FIG. 4 demonstrates a method for enhanced browsing, according to one embodiment of the invention. This method may be employed with apparatus 102 of FIG. 1 and is thus implemented on a user's client computing device, which is equipped with a browser.

In operation 402, the user's browser is opened at a web page or other collection of content, which may be considered the “browser page”, “first page” or “main browser page” herein to differentiate it from another page or other target content displayed in an enhanced browsing window.

In operation 404, the enhanced browsing apparatus applies default or custom rules to locate a target link on the browser page. Any number of additional target links may also be identified. For example, the apparatus may automatically locate all links on the browser page and treat them as target links. Or, the apparatus may apply a prefetch template, customized for the browser page, to identify links that are most likely to be of interest to the user.

A prefetch template may be stored (e.g., cached) within the enhanced browsing apparatus, or may be stored on a central server for retrieval by the apparatus before or when the browser page is opened. As yet another alternative, the template or other information for identifying (and/or prioritizing) target links may be retrieved from the same server that served the browser page, or may be received as part of the browser page.

In operation 406, content associated with the target link is prefetched. The target content may include all or a portion of the web page, document, image or other data identified by the target link. Thus, the target content may include HTML, XML or other markup language, but in this embodiment of the invention is not just an image of the content. As will be seen below, because the actual content is prefetched, it can be presented in a readable, understandable manner, and can be navigated (e.g., if it contains links). In particular, the prefetched content will not be presented as “thumbnails” or other non-navigable, often illegible, images.

One or more ads may also be retrieved, to display with the target content. As described above, the ads may be retrieved from any suitable ad source, and may be selected based on the target content, the browser page, search terms entered by the user, the user's browsing history, or other information.

In one embodiment of the invention, a target link changes appearance (e.g., color, font size, underlining, bold) to indicate when its content has been prefetched. Thus, a target link may first appear (in the browser page) in a first color (e.g., light blue), but then change to a different color (e.g., dark blue) after the target content has been fetched. In one implementation, multiple color palettes may be employed to allow link colors to be changed easily and rapidly.

Advantageously, after content for a target link is prefetched, if the user navigates the browser to that link (i.e., by clicking on it), the content can load almost immediately from the enhanced browsing apparatus' cache (or wherever else it was stored). Thus, the user's browsing experience is enhanced even without using an enhanced browsing window to preview content.

In operation 408, an enhanced browsing window is constructed and populated with the target content and any ads that were retrieved to accompany the content. The content may be resized or may retain its full size, in which case scroll bars may be provided for scrolling vertically and/or horizontally. In different implementations of this embodiment of the invention, ads that were received as part of the target content may be retained, excised or replaced.

In one implementation, when target content from multiple target links is prefetched, enhanced browser windows may be generated (but not displayed) for any number of the links. Thus, if content is prefetched for fifty target links, enhanced browsing windows may initially be generated for any number of the target links, from zero to fifty. Windows may be generated for the remainder later (e.g., after the user starts previewing content).

In operation 410, the enhanced browsing window is cached without being displayed. By constructing the window before it needs to be displayed, the enhanced browsing window can be presented almost instantly when the user indicates an interest in the target link. In the method of FIG. 4, a separate enhanced browsing window is constructed and cached for each target link whose content was prefetched. Thus, operations 404 through 410 may be repeated for any number of target links.

In operation 412, the enhanced browsing apparatus detects a user mouse-over or other selection of the target link. In one implementation, when a user interface cursor (e.g., mouse cursor, a cursor or selector controlled by the TAB key) appears over or adjacent to the target link or an icon or control associated with the link, a predetermined period of time (e.g., one second) may be required to pass before the window containing the target content will be switched to visible status. This time period may be adjustable by the user. Illustratively, if the user employs a keyboard for input (e.g., instead of a mouse), selection of the target link may be identified by the user's tabbing to the link and pausing for the necessary time period.

In operation 414, when it is determined that the user has moused-over or otherwise selected or expressed an interest in the target link, the enhanced browsing window is made visible. In one implementation, the window is approximately 75% of the size of the user's browser, and may be positioned adjacent to (or overlapping) the target link or a list of links that includes the target link. The screen cursor may be positioned within the enhanced browsing window, near (or over) the target link.

In optional operation 416, enhanced browsing may be extended to the target content so that the user can navigate the content or the enhanced browsing window. That is, one or more links within the target content may be treated as target links, in which case their associated content is prefetched. Then, if the user mouses-over a target link in the target content, another enhanced browsing window may be created to display the new target content. Or, the target content of the enhanced browsing window may be replaced with the new target content.

Illustratively, if the user clicks on the target link associated with the target content, or left-clicks (i.e., clicks the primary mouse button) within the target content (but not on a link), the browser page may be replaced by the target content or the page containing the target content. The same action may be taken if the user leaves the cursor motionless within the enhanced browsing window for a predetermined period of time (e.g., 5 seconds). If the user clicks on a link within the target content, the linked content may replace the target content within the enhanced browsing window or the user's browser may be directed to that content or page.

In operation 418, if the user moves the cursor out of the enhanced browsing window, it may close because it may be assumed that the user is no longer interested in viewing the target content. Or, right-clicking (clicking a mouse button other than the primary button) within the window (e.g., but not on a link) may cause it to close.

If the user moves the cursor from the window to a second target link, the window may disappear and be replaced with the enhanced browsing window constructed for the second target content (or the target content may be replaced by the second target content).

In one embodiment, the state of an enhanced browsing window may be retained for some period of time after it is closed. Then, if a link to the same content is moused-over or otherwise selected for enhanced browsing, the window may open with the same state (e.g., centered or scrolled to the same portion of the content).

As one skilled in the art will recognize, the enhanced browsing experience 25 described herein differs significantly from a traditional “pop-up” within a web page. Traditional pop-ups, when selected, merely display information that was received with or as part of the web page. In contrast, an enhanced browsing window displays content from a different page or source, and that content may be navigable. In one implementation, the enhanced browsing apparatus may be configured to suppress traditional pop-ups.

The illustrated method ends after operation 418.

In yet another implementation, the enhanced browsing apparatus is installed and operated at a central server. In this implementation a user navigates to the server to engage and employ the apparatus. This implementation may be well suited for thin clients.

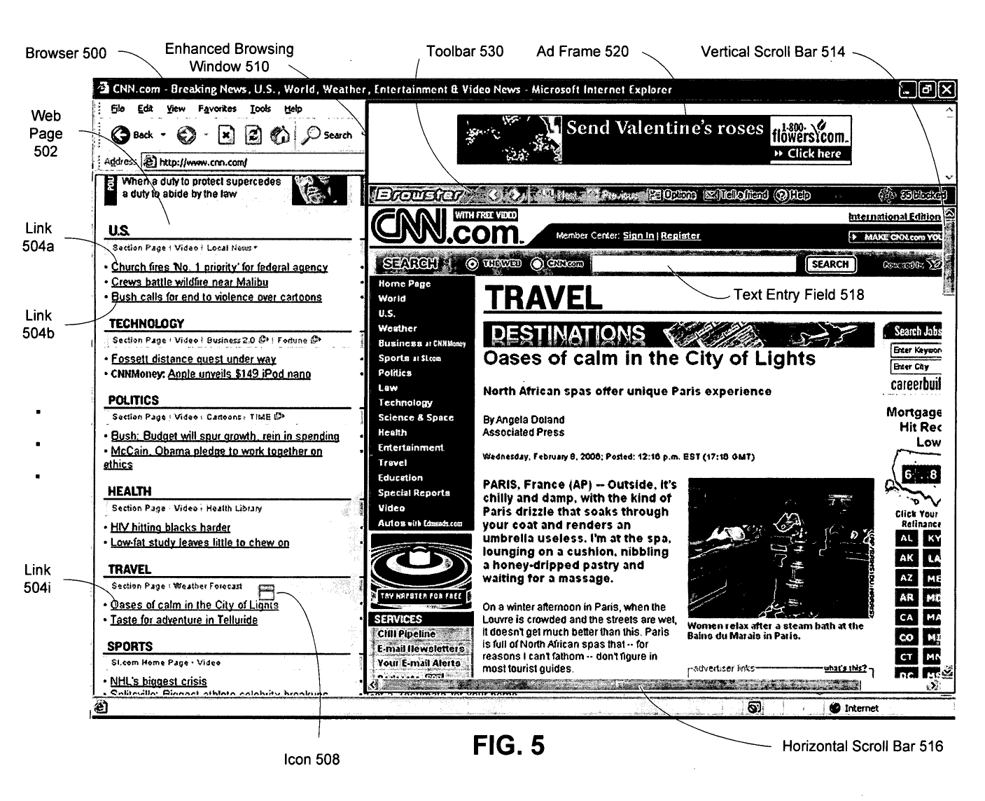

FIG. 5 depicts an enhanced browsing window according to another embodiment of the invention. In FIG. 5, browser 500 is open to web page 502, which contains a plurality of links 504 to other pages, including links 504a-504i.

When a user expresses an interest in link 504i (e.g., by placing a cursor over or near the link), icon 508 is displayed in association with the link. Icon 508 may be place near, over or adjoining the link, or at some distance from the link. Alternatively, icon 508 may be displayed even before the user expresses an interest in link 504i.

When the user places a cursor over or near icon 508, enhanced browsing window 510 is opened to display content fetched or prefetched via link 504i. A callout symbol or shadow (e.g., the triangular graphical object connecting icon 508 to the enhanced browsing window) may be displayed to visually indicate the source of the enhanced browsing window. Icon 508 and/or the callout symbol may be displayed for any period of time. For example, they may disappear after a short time period or when the user moves his cursor into enhanced browsing window, out of the shadow or takes other action. Or, the icon and callout symbol may be displayed for all or a substantial portion of the time enhanced browsing window 510 is open.

In this embodiment of the invention, enhanced browsing window 510 includes vertical scroll bar 514 and horizontal scroll bar 516 for scrolling the content of the target content. The enhanced browsing window also includes ad frame 520 and toolbar 530.

Toolbar 530 provides various tools or controls for altering the appearance and/or behavior of the user's enhanced browsing experience. For example, tools provided in the illustrated embodiment of the invention include buttons (e.g., left and right arrows) for navigating backward and forward through content displayed in enhanced browsing window 510, more buttons (e.g., down and up arrows) for navigating to content of the next or previous link 504 in web page 502 of browser 500, a pull-down menu for user selectable options, a control for initiating an electronic mail or instant message, access to help, and an indicator of how many cookies have been blocked from content fetched for display in the enhanced browsing window.

In one implementation of the embodiment of the invention depicted in FIG. 5, enhanced browsing window 510 is automatically converted into a full browser or browser page if a user takes some predetermined action. For example, if the user clicks within the target content displayed in the window (e.g., but not on a link or on a data entry field of a form), the window may be converted.

The resulting browser page may or may not be full-sized, and may replace or overlay browser 500, or browser 500 may be minimized. Any call-out symbol or shadow, as well as any link icon used to open the window (e.g., icon 508) is removed when the window is converted into a browser.

In another implementation, enhanced browsing window 510 may be converted into a browser or browser window if a user selects a form or data field, such as text entry field 518, enters data into a form or data entry field, or if the user opens a pull-down menu within the content displayed in the enhanced browsing window. Illustratively, this type of user activity may indicate that the user wishes to further interact with the previewed page.

In an embodiment of the invention described herein, an enhanced browsing window differs from a browser window in that a user can open and close an enhanced browsing window without clicking anything. As already described, an enhanced browsing window may be displayed when a user mouses-over or near a target link, and may be closed when the user mouses-out of it. The user does not have to manually close it (e.g., by clicking on a “Close” icon at the top right-hand corner) or clicking a “Back” or “Forward” icon.

Also, an enhanced browsing window may block cookies initiated by some or all web sites and may provide additional functionality as described herein or in U.S. patent application Ser. No. 10/985,700, which is incorporated herein by reference. For example, and as described below, one or more objects may be removed from a target web page before the page is presented in an enhanced browsing window; the objects would not be removed by a browser.

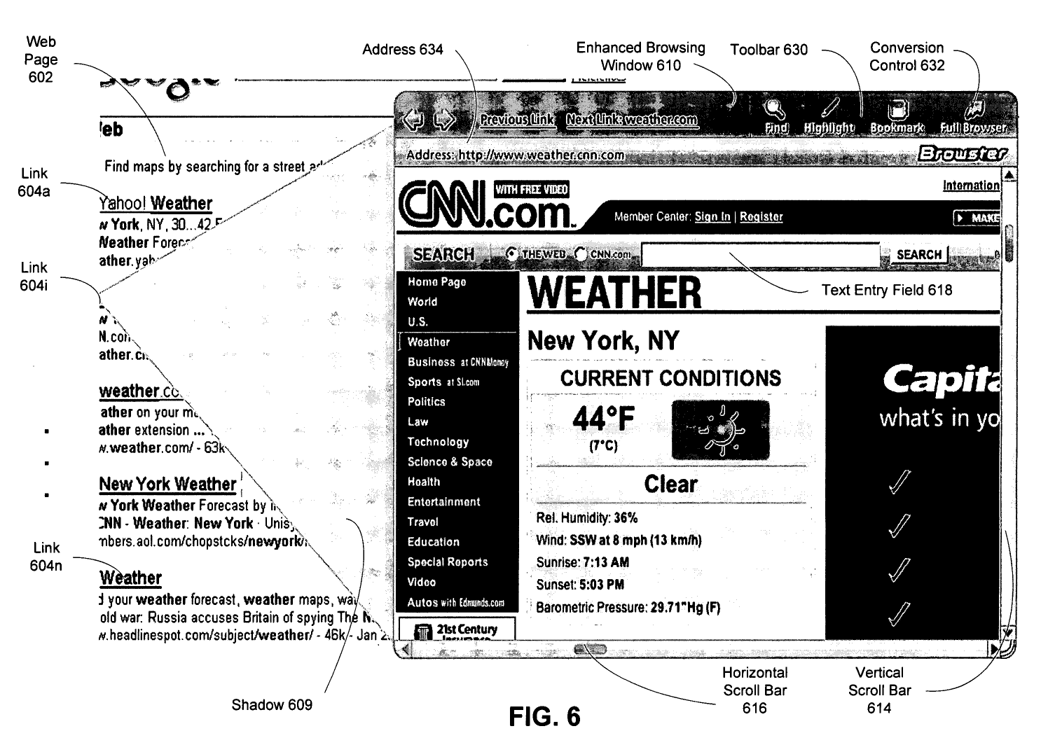

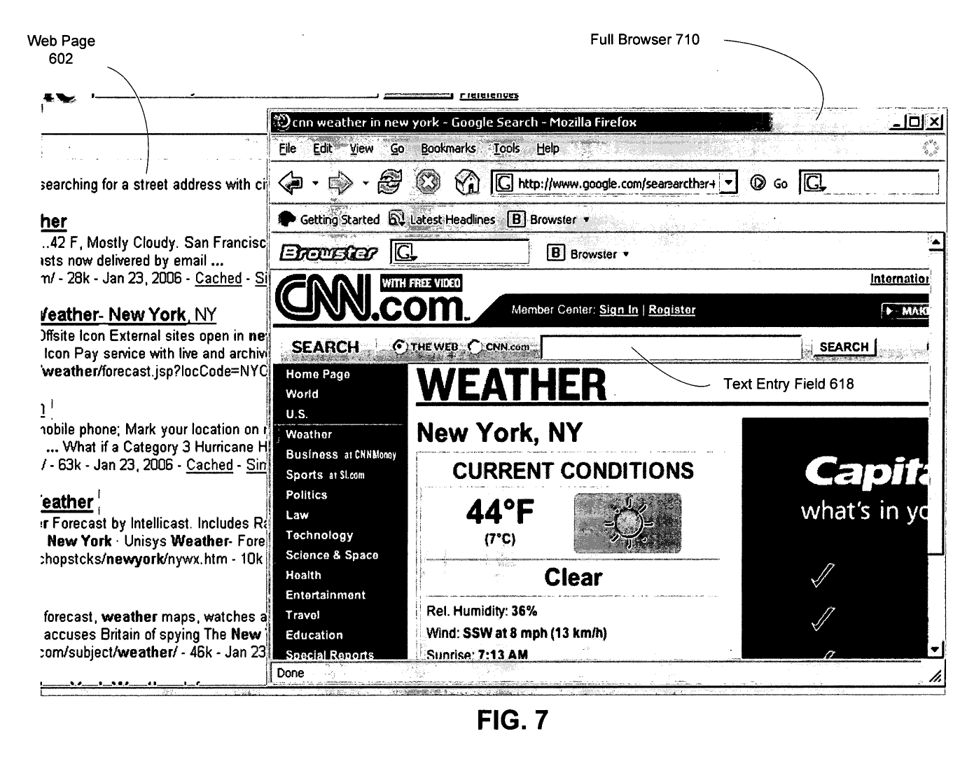

FIGS. 6-7 demonstrate another alternative embodiment of the invention in which an enhanced browsing window can be automatically converted into a full browser or full browser window.

In FIG. 6, web page 602 is displayed in a browser (e.g., Mozilla Firefox) and includes a set of links 604 (e.g., links 604a-604n) to other pages. Enhanced browsing window 610 has been opened to preview content from a link 604i, in response to a user's mouse-over of the link or an associated icon. Shadow 609 visually connects the enhanced browsing window to the icon or link associated with the content displayed in the window, thereby allowing a user to quickly determine which target link's content is being previewed.

Enhanced browsing window 610 includes vertical scroll bar 614, horizontal scroll bar 616, toolbar 630 and address 634, and the content displayed in the window includes text entry field 618. The toolbar includes various tools, including counterparts for some or all of the tools described above in conjunction with FIG. 5. Other controls or tools are also provided, such as a search tool (e.g., for finding text in the displayed content), a highlight tool for highlighting particular target content (e.g., text that matches a search term) and a bookmark tool for easily bookmarking the target link or content (e.g., by adding it to a folder of favorites).

In particular, however, toolbar 630 includes conversion control or tool 632 for converting enhanced browsing window 610 into a full browser (e.g., like the browser in which web page 602 is displayed). When a user clicks on conversion control 632 or, possibly, clicks on non-actionable content displayed within enhanced browsing window 610 (i.e., content that does not comprise a link, a data entry field or a control), the enhanced browsing window is automatically converted into a full browser and the target content is displayed within the browser, as shown in FIG. 7.

Full browser 710 of FIG. 7, converted from enhanced browsing window 610 of FIG. 6 may include any or all of the same toolbars and controls as the original browser window in which web page 602 is displayed. Full browser 710 may be sized and positioned to overlay a portion of the original browser window as shown in FIG. 7. Alternatively, full browser 710 may be maximized and the original browser window may be closed, resized (e.g., minimized) or otherwise modified. Because full browser 710 is a regular browser window, all normal browser functionality is provided.

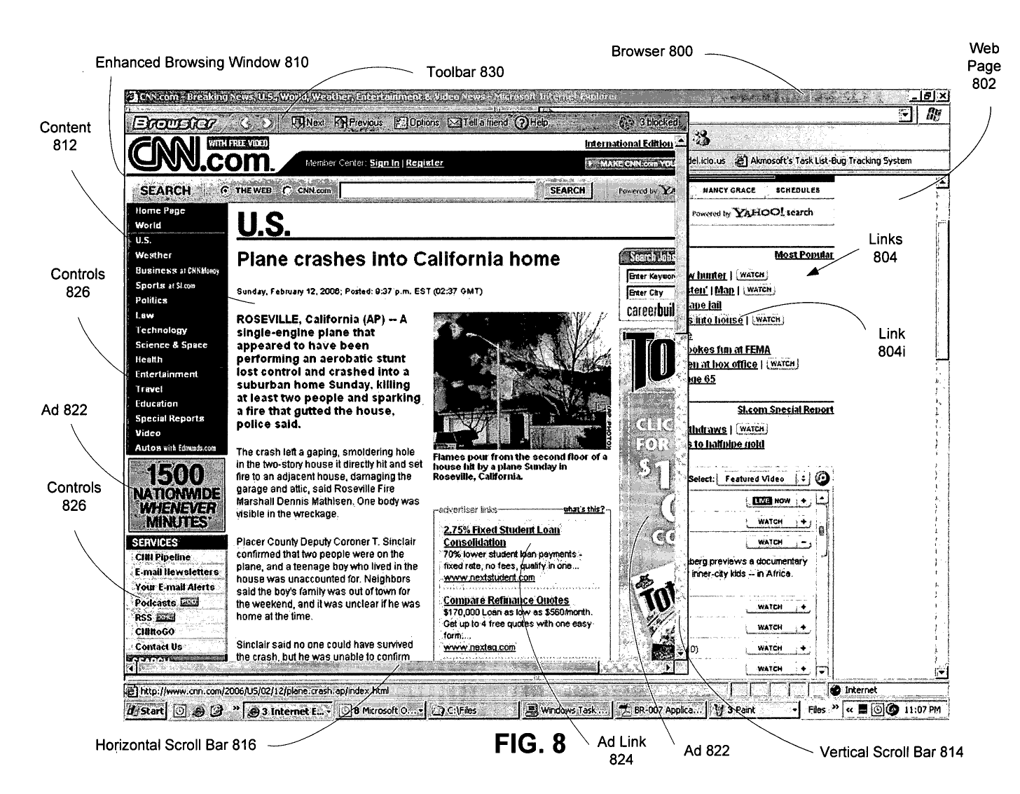

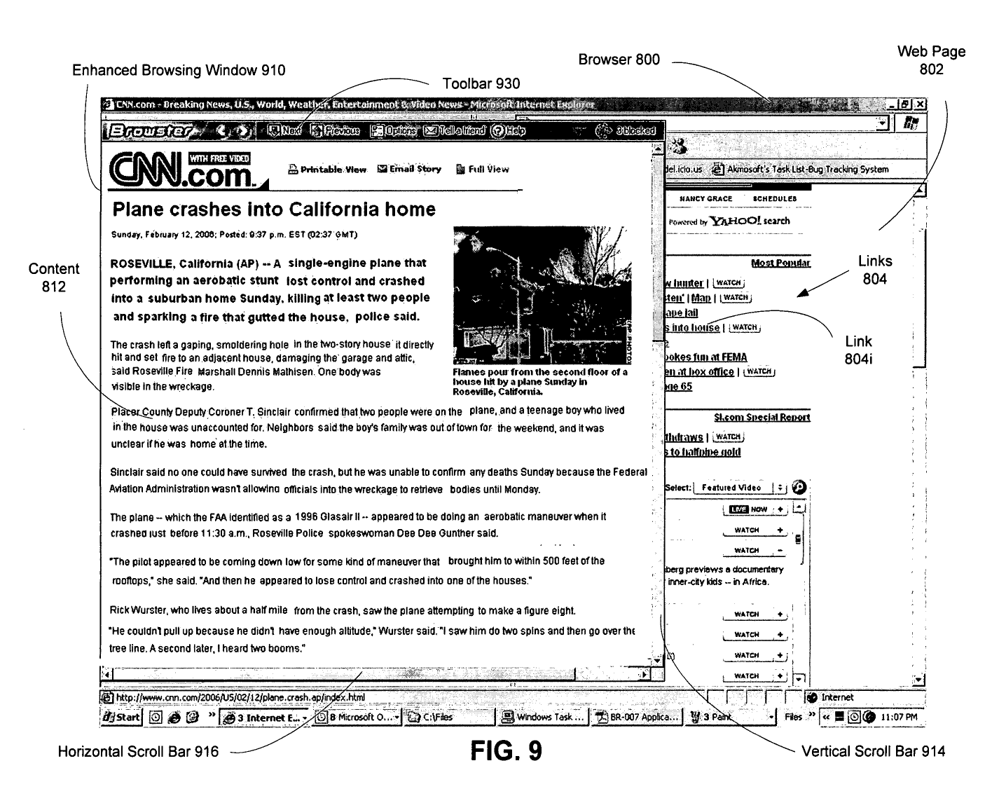

FIGS. 8 and 9 demonstrate an embodiment of the invention in which content retrieved via a target link is stripped of one or more objects or of some content. In FIG. 8 a popular web page 802 displayed in browser 800 contains links 804, including link 804i to a news story or article. The target content 812 is presented in enhanced browsing window 810 in substantially the same form with which it would be displayed in browser 800. In particular, content 812 includes or is accompanied by one or more advertisements 822, links 824 to advertisers or advertisements, controls 826 for navigating the web site or accessing related information, etc.

In FIG. 9, enhanced browsing window 910 implements an embodiment of the invention to display only (or primarily) the main content of content item 812—in this case, the text of the news story. Objects not part of the main content (e.g., advertisements 822, controls 826) were removed, deleted or simply not retrieved with the target content. Related objects, such as the illustrated photograph, however, are not removed. Enhanced browsing window 910 may be considered to present a “content-only” view of the news story. The enhanced browsing window may, however, include a logo or other branding indicating the source or provider of that content.

The embodiment of the invention illustrated in FIG. 9 may be well suited for use with web sites that serve news stories and other textual articles (or links to such content), but may also be operated to preview other types of content that may be cluttered with objects that obscure or attempt to distract one's attention from primary content. For example, product descriptions at a retail web site, product reviews, electronic mail messages, and any other type of content that may be augmented with extraneous objects may be previewed with less clutter using this embodiment of the invention.

Objects may be selected for removal from target content to be displayed in enhanced browsing window 910 based on their source (e.g., an ad server or site), type (e.g., advertisement, survey), location within the target content (e.g., a template may be used to identify objects to be retained or stripped), and/or other characteristics and factors. For example, objects (especially navigation controls or links) that are identical to objects displayed on the page containing the target link (e.g., web page 802) may be prime candidates for removal.

Note that images accompanying retained textual content, as in content 812 may be automatically retained, especially if it can be determined that they are related to the textual content (e.g., based on their location, size, source, filenames).

Enhanced browsing window 910 may present controls or tools (e.g., toolbar 930) for printing content 812 (i.e., without the stripped objects), sending it to another user via electronic mail or instant message, saving it, etc.

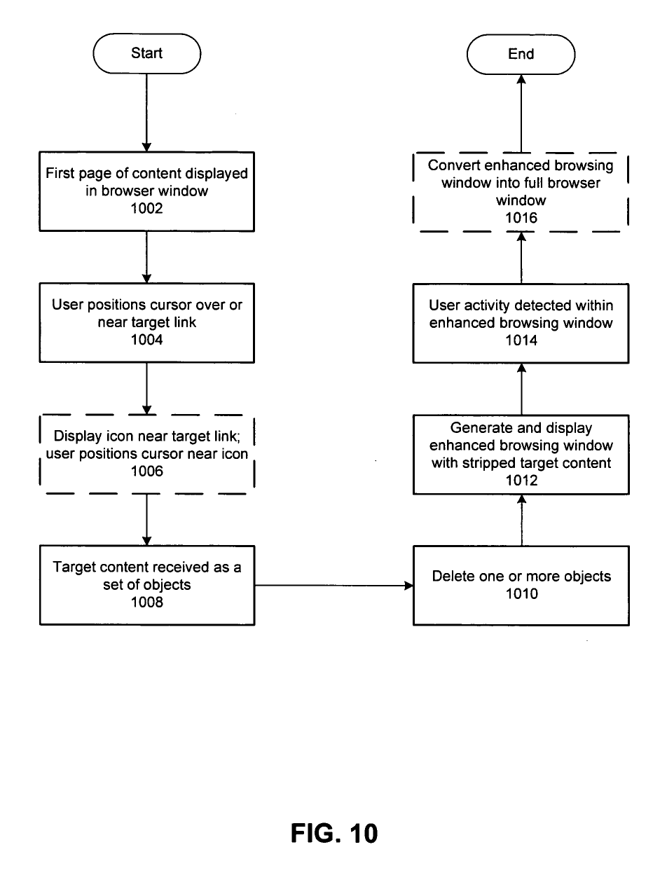

FIG. 10 is a flowchart demonstrating a method of enhanced browsing according to another embodiment of the invention. In this embodiment, extraneous objects may be stripped from target content to focus on the primary content, and an enhanced browsing window can be converted into a full browser window.

In operation 1002, a first page of content (e.g., web page) is displayed in a first browser window. The first page contains links to any number of other pages or content.

In operation 1004, with keyboard input, a mouse, or other pointing device, a user places a cursor over or near a link to a second page of content. In this embodiment, the user need not click on the link. Action may now be taken (e.g., by initiating an HTTP “GET” request) to fetch target content associated with the link.

In optional operation 1006, an icon (e.g., an enhanced browsing icon) is displayed near the link and near the cursor, and the user places the cursor over or near the icon. A request may be issued to retrieve the link's target content if not already issued.

In operation 1008, the target content is received as a collection of objects. Illustratively, the second page of content may comprise a set of links to objects to be displayed on that page. In response to a request for the second page, all those objects may be automatically sent to the requester.

In operation 1010, some subset of the objects is deleted or removed from the second page. As described above, for example, navigation controls for navigating a website may be removed, an ad may be deleted, links to other content may be excised. Illustratively, however, the primary content of the second page (e.g., an article) is retained, along with any images or graphics that relate to the primary content.

In one implementation, the second page is retrieved normally (e.g., using the target link), and then one or more objects are selectively deleted based on their file type, source, name, size, etc. As one alternative, the target link may be followed to the second page and retrieval of content may be limited to selected objects (e.g., the text of a news story, a photograph).

In operation 1012, an enhanced browsing window is generated and populated with the primary content of the second page. The enhanced browsing window is then positioned on top of or in front of the first browser window.

In operation 1014, the user takes some predetermined action, such as clicking on a conversion control within a toolbar of the enhanced browsing window, clicking on or within a form or data entry field in the primary content, etc.

In operation 1016, the window is converted into a full browser window. In this embodiment, a new browser window is created in substantially the same position, with substantially the same size, as the enhanced browsing window. Just the primary content may be displayed within the new browser window or, alternatively, the content that had been stripped from the second page may be included.

In one implementation, the conversion process involves generating a new browser window from the user's default browser (e.g., Internet Explorer, Mozilla Firefox) or a selected browser, and positioning it in place of the enhanced browsing window with approximately the same size. The content displayed within the enhanced browsing window is then loaded into the new browser window and the enhanced browsing window is deleted.

In other implementations, the conversion process may involve replacing the first browser window with a new fill-size browser window or generating a new browser window and overlaying it upon the first browser window. However implemented, some or all of the content of the enhanced browsing window is moved to a new browser window and the enhanced browsing window is closed. The actual behavior of the new browser window (e.g., size, position, focus) may depend on which control the user activates, what default behavior is set for the enhanced browsing window, etc.

The program environment in which a present embodiment of the invention is executed illustratively incorporates a general-purpose computer or a special purpose device such as a hand-held computer. Details of such devices (e.g., processor, memory, data storage, display) may be omitted for the sake of clarity.

It should also be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM) and/or non-volatile (e.g., ROM, disk, DVD) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

The foregoing embodiments of the invention have been presented for purposes of illustration and description only. They are not intended to be exhaustive or to limit the invention to the forms disclosed. Accordingly, the scope of the invention is defined by the appended claims, not the preceding disclosure.

What is claimed is:

1. A method of enhanced browsing of electronic content, the method comprising:
within a first browser window displaying a first electronic content item, detecting placement of a cursor in proximity to a link to other electronic content without clicking on the link;
in response to said detecting placement, displaying an enhanced browsing window comprising the other electronic content; and
in response to user activity within the enhanced browsing window, converting the enhanced browsing window into a second browser window.

2. The method of claim 1, wherein the user activity comprises selection of a control for initiating said converting.

3. The method of claim 1, wherein the user activity comprises entry of data into a data entry field within the other electronic content.

4. The method of claim 1, wherein the user activity comprises clicking within the enhanced browsing window.

5. The method of claim 1, wherein said detecting placement comprises:
detecting placement of the cursor over the link;
displaying an icon adjacent to the link; and
detecting placement of the cursor over or near said icon.

6. The method of claim 1, wherein the other content displayed in the enhanced browsing window comprises markup language.

7. The method of claim 1, wherein said converting comprises:
replacing the enhanced browsing window with the second browser window.

8. The method of claim 1, further comprising:
prefetching the other content prior to said detecting placement.

9. The method of claim 8, further comprising:
constructing the enhanced browsing window to contain the other content prior to said detecting placement; and
not displaying the enhanced browsing window until said detecting placement.

10. The method of claim 1, further comprising, prior to said displaying the enhanced browsing window:
removing one or more objects from the other electronic content.

11. The method of claim 1, wherein the first electronic content item comprises multiple links, including the link to the other content.

12. The method of claim 11, wherein the enhanced browsing window comprises a control for replacing the other content in the enhanced browsing window with content associated with another link in the multiple links.

13. The method of claim 11, wherein the multiple links comprise results of a search by a search engine.

14. The method of claim 11, wherein the multiple links comprise links to news articles.

15. The method of claim 11, wherein the multiple links comprise links to content describing things for sale.

16. A computer readable medium storing instructions that, when executed by a computer, cause the computer to perform a method of enhanced browsing of electronic content, the method comprising:
within a first browser window displaying a first electronic content item, detecting placement of a cursor in proximity to a link to other electronic content without clicking on the link;
in response to said detecting placement, displaying an enhanced browsing window comprising the other electronic content; and
in response to user activity within the enhanced browsing window, converting the enhanced browsing window into a second browser window.

17. A computer-implemented method of previewing content linked to a first electronic document, the method comprising:
in a first browser window displaying the first electronic document, detecting user interest in a link to the content, wherein the content comprises primary content desired by the user and one or more secondary objects that would be displayed with the primary content if the content were retrieved into the first browser window;
initiating retrieval of the primary content; and
displaying in an enhanced browsing window the primary content without the one or more secondary objects.

18. The method of claim 17, wherein said detecting user interest comprises detecting placement of a cursor over or adjacent to the link to the content.

19. The method of claim 17, wherein said detecting user interest comprises detecting placement of a cursor adjoining an icon associated with the link to the content.

20. The method of claim 17, further comprising:
detecting user activity in the enhanced browsing window; and
in response to the user activity, converting the enhanced browsing window into a second browser window.

21. The method of claim 17, wherein said initiating retrieval comprises:
receiving the primary content and the one or more secondary objects;
separating the primary content from the one or more secondary objects.

22. The method of claim 17, wherein said initiating retrieval comprises:
applying a content filter to distinguish the one or more secondary objects from the primary content.

23. The method of claim 22, further comprising:
retrieving the content; and
dropping the one or more secondary objects.

24. The method of claim 17, wherein said initiating retrieval comprises:
applying a content filter to identify the primary content.

25. The method of claim 24, further comprising:
retrieving the primary content without the one or more secondary objects.

26. The method of claim 17, wherein the one or more secondary objects include a set of navigation controls for navigating a website comprising the first electronic document.

27. The method of claim 17, wherein the one or more secondary objects include an advertisement.

28. The method of claim 17, wherein the primary content comprises a news story.

29. The method of claim 17, wherein the primary content comprises text that is not part of an advertisement or a navigation control.

30. The method of claim 17, wherein the enhanced browsing window is displayed without the user clicking in the first browser window.

31. A computer readable medium storing instructions that, when executed by a computer, cause the computer to perform a method of previewing content linked to a first electronic document, the method comprising:
in a first browser window displaying the first electronic document, detecting user interest in a link to the content, wherein the content comprises primary content desired by the user and one or more secondary objects that would be displayed with the primary content if the content were retrieved into the first browser window;
initiating retrieval of the primary content; and
displaying in an enhanced browsing window the primary content without the one or more secondary objects.

32. An apparatus for facilitating previewing of electronic data, the apparatus comprising:
a first browser configured to display a first page of electronic data comprising links to other pages;
an enhanced browsing window configured to display a second page of electronic data while the first browser displays the first page; and
a user interface configured to:
detect the positioning of a cursor on or proximate to a link to the second page;
construct the enhanced browsing window;
display the enhanced browsing window only after said detection of the positioning of the cursor; and
convert the enhanced browsing window into a second browser in response to predetermined user activity within the enhanced browser window.

33. The apparatus of claim 32, wherein the user interface is configured to display the enhanced browsing window without requiring a click within the first browser.

34. The apparatus of claim 32, further comprising:
a customizer configured to remove one or more objects from the second page prior to displaying the enhanced browsing window;
wherein the one or more objects would be displayed by the first browser if the second page were retrieved by the first browser.

35. The apparatus of claim 34, wherein the one or more objects comprise a navigation control for navigating a web site comprising either or both of the first page and the second page.

36. The apparatus of claim 34, wherein the one or more objects comprise an advertisement.

37. The apparatus of claim 32, wherein the user interface is further configured to:
remove one or more objects from the second page prior to displaying the enhanced browsing window;
wherein the one or more objects would be displayed by the first browser if the second page were retrieved by the first browser.

38. The apparatus of claim 32, wherein the predetermined user activity comprises selection within the enhanced browsing window of a conversion control configured to initiate said conversion.

39. The apparatus of claim 32, wherein the predetermined user activity comprises entry of data into a data entry field within the enhanced browsing window.

40. A graphical user interface for facilitating enhanced browsing of electronic data, comprising:
a fetcher configured to fetch a second page of electronic content linked to a first page of electronic content displayed in a first browser window;
an enhanced browsing window configured to display content from the second page of electronic content after a cursor is placed adjoining a link from the first page to the second page but without requiring a click within the first browser window;
a customizer configured to remove one or more visual objects from the second page of electronic content prior to displaying the second page of electronic content in the enhanced browsing window; and
a converter configured to convert the enhanced browsing window into a second browser window in response to predetermined user activity within the enhanced browsing window.

41. The graphical user interface of claim 40, wherein the one or more visual objects would not be stripped from the second page of electronic content if the second page of electronic content was retrieved for display within the first browser window.

42. The graphical user interface of claim 40, wherein:
said fetcher prefetches the second page of electronic content before the cursor is placed adjoining the link.

43. The graphical user interface of claim 42, wherein:
said enhanced browsing window is constructed, but kept invisible, after the content from the second page is prefetched.
